(19) United States
(12) Patent Application Publication
(10) Pub. No.: US 2007/0175496 A1
(43) Pub. Date: Aug. 2, 2007

(54) CLEANING METHOD WITH CHEMICAL AGENT AND CLEANING APPARATUS WITH CHEMICAL AGENT

(75) Inventor: BRIAN RATTRAY, Ashigarakami-Gun (JP)

Correspondence Address: J C PATENTS, INC., 4 VENTURE, SUITE 250, IRVINE, CA, 92618, US

(73) Assignee: HITACHI HIGH-TECHNOLOGIES CORPORATION, TOKYO (JP)

(21) Appl. No.: 11/668,678

(22) Filed: Jan. 30, 2007

(30) Foreign Application Priority Data
Jan. 31, 2006 (JP) 2006-022189

(51) Int. Cl. B08B 7/04; B08B 3/00; B08B 3/12; B08B 3/04

(52) U.S. Cl. 134/10; 134/18; 134/56 R; 134/184; 134/109; 134/111; 134/104.2

(57) ABSTRACT

A cleaning apparatus with chemical agent circulation is provided, in which the apparatus airlock resulted from the air intrusion into the circulating path caused by bubbles generated by the cleaning process can be prevented. When the chemical agent is discharged from the overflow tank, spiral vortexes may generate near the outlet depending on the liquid level. A liquid level detecting sensor is provided to detect that the liquid level has arrived at a position at which no spiral vortex is generated, which is slightly above the height of the liquid level. The chemical agent cleaning is performed when the chemical agent is stored in the overflow tank, so that no air bubbles is generated in the chemical agent discharged from the overflow tank or mixed into the spiral vortexes or sent to a side of the chemical agent storing tank.

### CROSS-REFERENCE TO RELATED APPLICATION

This application claims the priority benefit of Japan application serial no. 2006-022189, filed Jan. 31, 2006. All disclosure of the Japan application is incorporated herein by reference.

### BACKGROUND OF THE INVENTION

1. Field of the Invention

The present invention relates to a method for cleaning the contamination of a product, such as wafer, hard disk, and disk, by using a rinse solvent, such as chemical agents, and a product cleaning apparatus. More particularly, the present invention relates to a chemical agent cleaning method, in which the chemical agent is circulated between a rinse tank and a chemical agent storing tank while performing the cleaning, and to a chemical agent cleaning apparatus.

2. Description of Related Art

As for a substrate of a hard disk, for example, the chemical agent cleaning is performed after a process of grinding, polishing, sputtering, and plating. When a disk, such as the hard disk and a wafer, is cleaned with a chemical agent, the method substantially includes a plurality of cleaning processes and a drying process after cleaning.

It is known that, in the cleaning process, an apparatus is generally used, in which a bracket (or a tray) with a plurality of disks vertically arranged therein is immersed into a rinse tank where a cleaning liquid (a chemical agent) is stored, and cleans the disks with ultrasonic waves. Meanwhile, in the disk drying process after cleaning, the bracket (or tray) is directly transferred into the drying chamber and dried therein.

In Japanese Patent Laid-Open Publication No. 2001-96245, a scrubbing apparatus is disclosed, which is used to replace the bracket for cleaning disks; and particularly, a conveyer apparatus, such as a conveyer belt is respectively disposed on a shower rinse tank, a chemical agent rinse tank, an ultrasonic rinse tank and a purified water rinse tank, and the disk is conveyed to each tank by the conveyer belt, which allows the disk to move successively in each tank for being cleaned.

When cleaning a product in the ultrasonic rinse tank, a rinse solvent is used as a chemical agent. In a cleaning apparatus using such a chemical agent, the chemical agent is usually circulated as follows. For example, a chemical agent tank (chemical agent storing tank) and an ultrasonic rinse tank are disposed parallel to each other, the chemical agent is supplied from the chemical agent tank to the ultrasonic rinse tank, and the chemical agent, which overflows from the top end of the ultrasonic rinse tank due to the chemical agent supply, flows back to the chemical agent tank. Such a product cleaning method and a cleaning apparatus using the circulation manner is disclosed in Japanese Patent Laid-Open Publication No. 2002-167240.

In the cleaning apparatus disclosed in Japanese Laid-Open Publication No. 2001-96245 above, when a chemical agent tank and an ultrasonic rinse tank are disposed parallel to each other, the base area of the entire cleaning apparatus becomes larger. While performing continuous cleaning for a long term, it is necessary to have a big chemical agent tank. Therefore, the problem of having to enlarge the size of the entire apparatus occurs.

Currently, hard disk has been widely used in fields of automobile products, home appliance products and audio-visual products. A hard disk drive (HDD) of 2.5 inches to 1.8 inches and less than or equal to 1.0 inch, for example, 0.85 inches is used, and the HDD itself is getting smaller and smaller.

Accompanied with the miniaturization of the HDD, the cleaning apparatus itself also has the trend to be miniaturized. Technicians in this field has developed a method to reduce the base area to be as small as possible by disposing the chemical agent tank under the ultrasonic rinse tank, in particular under the base surface. If the chemical agent tank is disposed under the ultrasonic rinse tank, and the liquid level of chemical agent tank is lower than that of the ultrasonic rinse tank, the chemical agent spills over rapidly from the ultrasonic rinse tank to the chemical agent tank due to the difference in height of the two liquid levels. Hence, it is highly probable that the chemical agent bubbles would be generated in the chemical agent tank. As a result, a sealed reflux path is generally used, which is formed by sealing the sides of the chemical agent tank. However, the reflux path including the chemical agent tank is designed to be sealed for performing chemical agent filtration or purification on a side face of the chemical agent tank. Consequently, a higher cost is resulted, which then fails to satisfy the current demands.

Generally, a cleaning method and a cleaning apparatus with circulated chemical agent below are used, i.e., the chemical agent overflowed out of an ultrasonic rinse tank is stored in an overflow tank temporarily, and the chemical agent is refluxed to the chemical agent tank from the overflow tank. However, even an overflow tank is utilized, when the chemical agent stored in the overflow tank overflows out of the ultrasonic rinse tank and refluxes to the chemical agent tank it is of great potential that the chemical agent overflows out of the overflow tank and flows into the chemical agent tank and chemical agent bubbles may be generated in the chemical agent tank since the same chemical agent is located on the downstream of the ultrasonic rinse tank. Additionally, because it is of great potential that the chemical agent overflows out of the ultrasonic rinse tank and air bubbles are generated inside the chemical agent in the overflow tank, the air bubbles may reflux into the chemical agent tank through the reflux path. As described previously, the air bubbles (air) contained in the chemical agent can adhere to the inside of the reflux path or adhere to a drive pump for circulation. Consequently, the cleaning apparatus may be in an airlock state, leading to a cessation of the circulation of the chemical agent.

When the cleaning apparatus is in an airlock state, it is necessary to perform an air removal operation in order to remove the air adhered onto the reflux path or on the circulating pump. The air removal operation itself is time consuming. If the air removal operation is conducted frequently, the product cleaning can not efficient.

### SUMMARY OF THE INVENTION

The present invention is directed to provide a chemical agent cleaning method and a chemical agent cleaning apparatus to address the problems in the prior art. In the chemical agent cleaning apparatus with circulating chemical agent, the apparatus airlock, which is caused by the intrusion of air bubbles in the chemical agent in the circulating path, could be prevented to the full extent.

According the present invention, the chemical agent cleaning method, comprising immersing a product into a chemical agent in the chemical agent rinse tank for cleaning, includes the following steps: a chemical agent is provided to a chemical agent rinse tank from a chemical agent storing tank, which is disposed in a position lower than the chemical agent rinse tank; the chemical agent overflowed out of the chemical agent rinse tank is temporarily stored in an overflow tank; at a time point when a chemical agent storing level in the overflow tank reaches a first setting value, i.e., a position lower than the upper portion of the wall of the overflow tank, the chemical agent refluxes from the overflow tank to the chemical agent storing tank, and at a time point when the chemical agent storing level in the overflow tank caused by the reflux of the chemical agent reaches a second setting value, i.e. a position lower than the first setting value, the chemical agent are stopped from refluxing from the overflow tank to the chemical agent storing tank, and the chemical agent is maintained being stored in the overflow tank.

In other words, the chemical agent cleaning method according to the present invention is conducted as follows. A specified amount of the chemical agent that should be supplemented into the chemical agent tank is detected, or the chemical agent exceeding this amount that has been stored in the overflow tank is detected, by a first liquid level detecting sensor, which is disposed in the overflow tank. According to this detection scheme, a switch valve which is disposed in the flow path communicating between the overflow tank and the chemical agent tank is opened, so as to allow the chemical agent in the overflow tank to reflux to the chemical agent tank. Further, a second liquid level detecting sensor, which is disposed in the overflow tank is used to detect the height of the spiral vortexes generated in the chemical agent resulting from the decreasing of the liquid level, or the amount of the chemical agent when the height of the liquid level thereof reaches a position higher than this height is detected. According to this detection scheme, the switch valve is closed next time, and the chemical agent cleaning is performed in a state that the chemical agent is maintained being always stored in the overflow tank.

According to the present invention, the second liquid level detecting sensor is disposed to detect the height of the chemical agent level when spiral vortexes started to generate at the outlet of the overflow tank, or to detect the height of the liquid level of the chemical agent discharged around the outlet. Therefore, even if air bubbles are generated in the chemical agent discharged from the overflow tank, the air bubbles would not be engulfed in the spiral vortex. Instead, the air bubbles would reflux to the sides of the chemical agent tank.

In addition, the inventors of the present invention have investigated the airlock problem and have concluded that the chemical agent bubbles engulfed in the spiral vortex and intruded the outlet reflux path upon the generation of the spiral vortex. Further, the chemical agent bubbles disintegrate near the switch valve, and the airlock is thereby generated, leading to the cessation of the chemical agent circulation in the cleaning apparatus.

Because the liquid level detecting position of the first liquid level detecting sensor is set at the height of the liquid level of either the specified amount of the chemical agent that should be supplemented to the chemical agent tank or the chemical agent exceeding this amount that has been stored in the overflow tank, the problem regarding the amount of the chemical agent being provided to the chemical agent rinse tank from chemical agent tank can be obviated, even the chemical agent level rises according to the amount of the residual chemical agent during discharged.

According to the present invention, the following effects are achieved. In the chemical agent cleaning apparatus with circulating chemical agent, the cleaning apparatus airlock generated during cleaning due to air intrusion into the circulating flow path by the chemical agent bubbles is substantially prevented. Therefore, frequency of the air removal operation on the chemical agent tank and the reflux path is reduced, and product cleaning can be performed with high efficiency.

### BRIEF DESCRIPTION OF THE DRAWINGS

FIG. 1 is an explanatory drawing of the main portions of a chemical agent cleaning apparatus for a product according to an embodiment of the present invention.

FIG. 2 is a flow chart of process steps of the circulation control of a chemical agent.

FIG. 3 is a schematic structural diagram of a floating type liquid level sensor disposed in an overflow tank.

### DESCRIPTION OF EMBODIMENTS

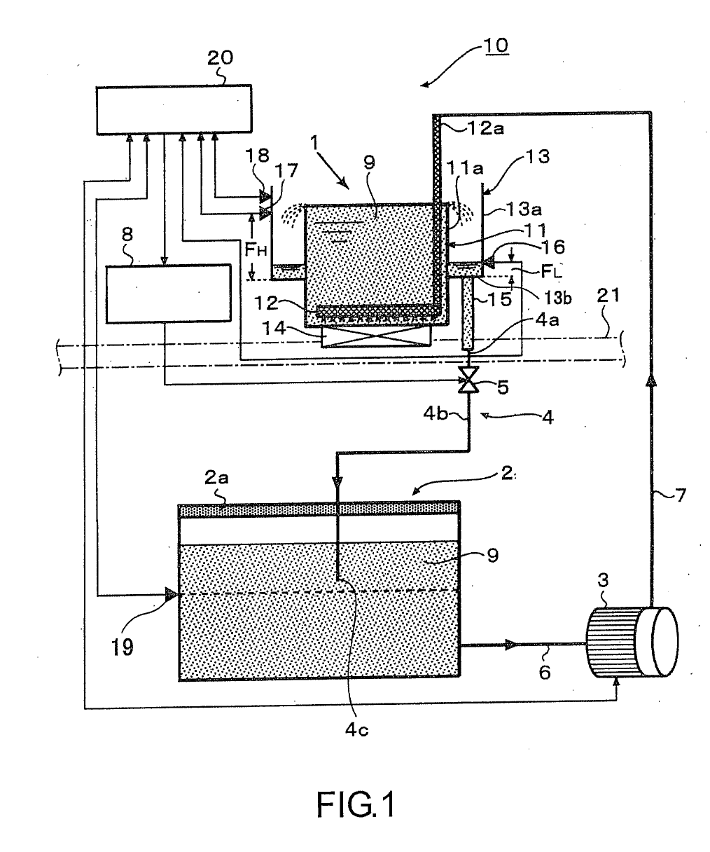

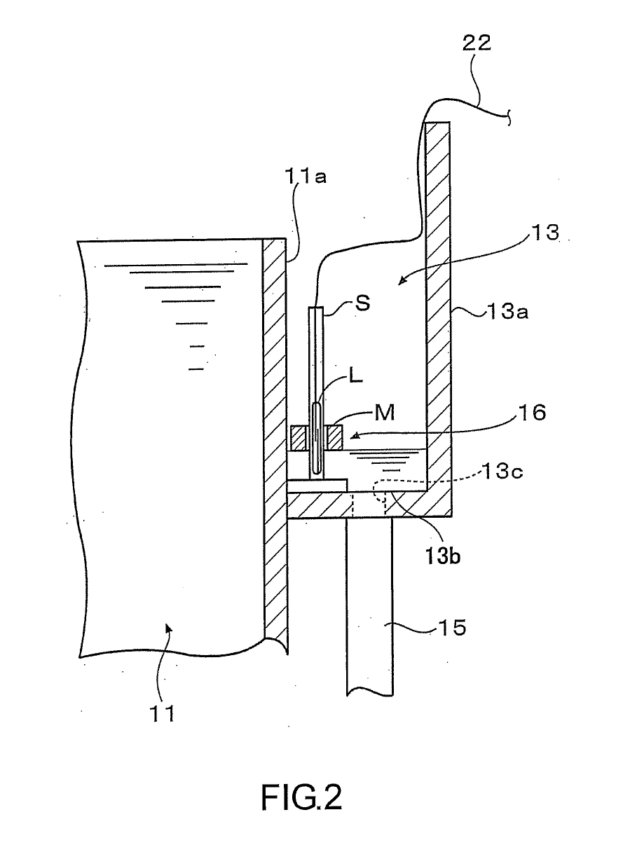

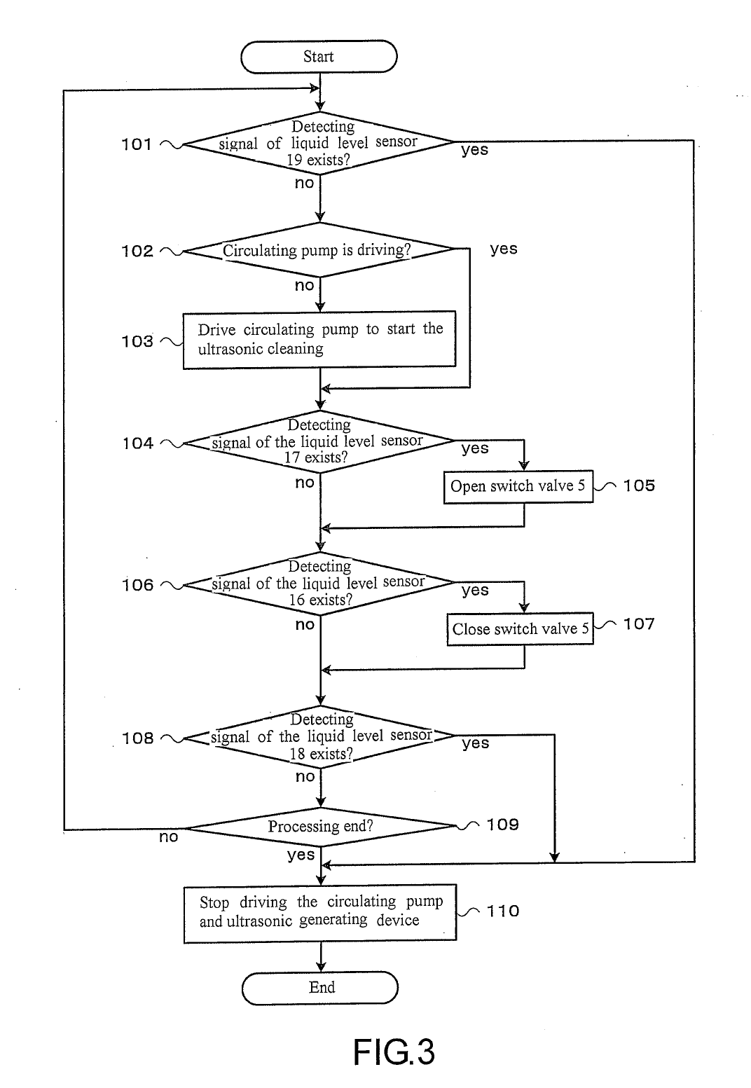

Hereafter, the preferred embodiments according to the present invention is illustrated with reference to the drawings. FIG. 1 is an explanatory diagram of the main portions of a chemical agent cleaning apparatus for a product according to an embodiment of the present invention. FIG. 2 is a flow chart of process steps of the circulation control of a chemical agent. FIG. 3 is a schematic structural diagram of a floating type liquid level sensor disposed in an overflow tank.

As shown in FIG. 1, the chemical agent cleaning apparatus 10 for a product includes an ultrasonic rinse tank 1, a chemical agent tank 2, a circulating pump 3, an outlet reflux path 4, a switch valve 5, chemical agent supply paths 6 and 7, valve driving mechanism 8, and a controller 20.

The ultrasonic rinse tank 1 is located over the chemical agent tank 2 with a bottom surface 21 between the two. The ultrasonic rinse tank 1 includes: a chemical agent rinse tank 11, having a shape of a rectangular frame (cuboid or cube); an L-shaped chemical agent disperse supply nozzle 12, disposed along the internal wall face of the chemical agent rinse tank 11; an overflow tank 13, disposed to embrace the upper periphery of the chemical agent rinse tank 11 and protruded as a flange to retain the chemical agent overflowed from the chemical agent rinse tank 11; and an ultrasonic generating apparatus 14, disposed to connect with the external side of the bottom wall of the chemical agent rinse tank 11. The chemical agent disperse supply nozzle 12 has an inlet pipe 12a extending from the upper-edge of the chemical agent rinse tank 11 to a position above the chemical agent rinse tank 11. The shape of the ultrasonic rinse tank 1 also can be cylindrical shape and the like, other than a rectangular frame.

The product, such as a disk and a substrate thereof (substrate body) to be cleaned with the chemical agent cleaning apparatus 10 is transferred to the upper portion of the chemical agent rinse tank 11 by a handling robot (not shown) with a bracket (or tray), and is immersed into the chemical agent rinse tank 11.

The overflow tank 13 has a wall surface 13a higher than the upper portion of an external wall 11a of the chemical agent rinse tank 11. In the drawing, the height of the wall 13a of the overflow tank 13 can be same as that of the external face 11a of the chemical agent rinse tank 11, or can be lower than that of the chemical agent rinse tank 11. Generally, the chemical agent storing level in the overflow tank 13 can be any storing level, as long as the chemical agent can be stored temporarily. However, in the present embodiment, even if the chemical agent 9 stored in the chemical agent tank 2 is stored in the overflow tank 13 as the amount of chemical agent that can be stored in the overflow tank 13, the amount of the chemical agent in the chemical agent tank 2 will not be less than the stored amount of the minimum level of the chemical agent. In essence, the following operations are performed in the chemical agent tank 2. At a time point when the amount of the chemical agent in the chemical agent tank 2 reaches the minimum amount, which is at a position when no bubbles floating in the chemical agent tank 2 is mixed into the chemical agent provided to the overflow tank 13, the operation of the entire apparatus is stopped, and purified water is supplemented to the chemical agent tank 2. Therefore, when the storing level of the overflow tank 13 is large enough, the chemical agent is stored in the overflow tank 13; thus, the amount of the chemical agent in the chemical agent tank 2 reaches the minimum amount, and the apparatus is stopped frequently. Such a situation should be avoided. Additionally, the height of the wall 13a of the overflow tank 13 is set to be sufficiently higher than that of the upper portion of the outer wall 11a of the chemical agent rinse tank 11. The chemical agent flowed into the overflow tank 13 is thereby prevented from spattering out of the overflow tank 13.

As shown in FIG. 1, an outlet 13c is disposed on the bottom surface 13b of the overflow tank 13, with an outlet pipe 15 and an outlet reflux path 4a connected thereto. A switch valve 5 for controlling the on/off operation is provided along the outlet reflux path 4a. When the switch valve 5 is opened, the chemical agent 9 flows from the chemical agent rinse tank 11, and the chemical agent 9 stored in the overflow tank 13 passes through the outlet 13c, the outlet pipe 15, the outlet reflux path 4a, the switch valve 5 and the outlet reflux path 4b to enter into the chemical agent tank 2. The front end 4c of the chemical agent outlet side of the outlet reflux path 4b is located at a position sufficiently lower than the chemical agent level of the chemical agent tank 2.

The stored chemical agent 9 entering the chemical agent tank 2 is sucked by a circulating pump 3 via the chemical agent supply path 6. The chemical agent 9 is further being provided to the inlet pipe 12a of the chemical agent disperse supply nozzle 12 via the chemical agent supply path 7, and the chemical agent 9 is introduced to the bottom side of the chemical agent rinse tank 11 via a plurality of openings disposed on the bottom of the chemical agent disperse supply nozzle 12. The chemical agent 9 in the chemical agent rinse tank 11 increases slowly due to the chemical agent 9 being sucked from the chemical agent tank 2 by the circulating pump 3. The increased amount of the chemical agent 9 overflows into the overflow tank 13. As a result, the chemical agent 9 is circulated between the chemical agent rinse tank 11 and the chemical agent tank 2.

In the overflow tank 13, the floating type liquid level sensors 16-18 are disposed at the positions depicted by black triangles respectively. Similarly, the floating type liquid level sensor 19 is also disposed in the chemical agent tank 2. FIG. 3 shows the structure of an example of such a floating type liquid level sensor 16.

As shown in FIG. 3, the liquid level sensor 16 includes a hollow cylinder shaped (ring shaped) magnet M and a thin strut S. The magnet M floats on the liquid level, and the thin strut S had a reed switch L inserted into the hollow portion of the magnet M. The magnet M floats on the liquid level of the chemical agent 9 in the overflow tank 13, and moves up and down along the strut S corresponding to the liquid level of the chemical agent 9. When the magnet M moves upward along the strut S and reaches a position corresponding to the joint position of the reed switch L, the reed switch L is set to be in an ON state. The conducting wires 22 of the reed switch L are connected to the controller 20 in FIG. 1, so that the controller 20 can generally determine the joint state of the reed switch L.

The liquid level sensor 16 with the structure described above can detect any liquid level height of the liquid by appropriately adjusting the position of the reed switch L in the strut S in the height direction. In the present embodiment, the liquid level sensor 16 is used to detect the height from the bottom face 13b of the overflow tank 13 to the position F_{L} for preventing the air bubbles from being discharged. Upon the chemical agent 9 in the overflow tank 13 being slowly discharged from the outlet 13c, which results in the decrease in the amount of chemical agent 9, and the position, at which the spiral vortexes are likely to be generated along the flowing direction of the chemical agent 9 being sucked in via the outlet 13c, is set to be the lowest position the position F_{L} for preventing the air bubbles from being discharged is set to be the position a little higher than the lowest position (the position that is considered to have no spiral vortex being generated). By setting the position F_{L} for preventing the air bubbles from being discharged according to the invention, the amount of the chemical agent always remained in the overflow tank 13 is determined.

When the chemical agent 9 in the overflow tank 13 is discharged and the spiral vortexes are generated near the outlet 13c, the chemical agent bubbles are mixed into the spiral vortexes to intrude the outlet reflux path 4. When the chemical agent bubbles disintegrate near the switch valve 5, airlock is resulted. Therefore, that the chemical agent circulation in the apparatus has stopped can be determined. Additionally, even the concentration is lower, airlock still occurs when the chemical agent bubbles intrude the circulating pump 3. Further, after the apparatus has been setup, the generation of spiral vortexes during an experiment is observed, while the position F_{L} for preventing air bubbles from being discharged is appropriately set correspondingly.

The liquid level sensor 17 is a floating type sensor for detecting the upper limit of the liquid level of the chemical agent 9 in the overflow tank 13, and it is structurally the same as the above-mentioned liquid level sensor 16. The liquid level sensor 17 is used to detect the height of liquid level F_{H} of the outlet starting position of the chemical agent 9 in the overflow tank 13. It is also used to detect whether the chemical agent amount, at the upper side of the chemical agent residual amount located at the place where the position of the chemical agent amount was sufficiently higher than the position F_{L} for preventing air bubbles from being discharged reaches the designated chemical agent amount that should be supplemented to the chemical agent tank 2. In other words, whether a designated amount of chemical agent is stored in the overflow tank 13 is detected.

In the present embodiment, the liquid level height F_{H} in the overflow tank 13 is used to define the amount of chemical agent that can be stored in the overflow tank 13. That is to say, the liquid level height F_{H} is substantially higher than the position F_{L} for preventing air bubbles from being discharged, the liquid level height F_{H} is preferably defined to be near a position lower than the upper end of the chemical agent rinse tank 11. Also, as described above, the detecting position of the liquid level sensor 16 is set to a little higher than the lowest position at which the spiral vortexes can be generated, so as to allow the height from the position F_{L} for preventing the air bubbles from being discharged to the liquid level height F_{H} being large enough to ensure that the amount of the chemical agent 9 discharged from the overflow tank to the chemical agent tank 2 being a maximum. Also, when the height from the position F_{L} for preventing the air bubbles from being discharged to the liquid level height F_{H} is large enough to allow the switch valve 5 to perform an opening control (open operation), the output pressure (water pressure) of the chemical agent 9 from the overflow tank 13, through the outlet 13c, the outlet pipe 15, the outlet reflux path 4a, the switch valve 5, the outlet reflux path 4b and into the chemical agent tank 2 is sufficiently large to remove all the air adhered along the reflux path and discharge into the chemical agent tank 2. The above effect is resulted from driving the switch valve 5 with an open/close control.

In addition, the liquid level sensor 18 is set corresponding to a position a little higher than the near-full liquid level of the chemical agent 9 in the chemical agent rinse tank 11, or is set at a position around a position lower than the upper end of the overflow tank 13. The liquid level sensor 18 is a floating type sensor and is used to stop the circulating pump 3 from driving. That is to say, the liquid level sensor 18 is set to prevent the chemical agent 9 stored in the overflow tank 13 from exceeding the near-full liquid level height of the chemical agent rinse tank 11 and overflowing out of the overflow tank 13, when airlock occurs a cessation of the chemical agent circulation of the apparatus is resulted.

The liquid level sensor 19 is a floating type sensor disposed on the side of the chemical agent tank 2, and it is located under the upper lid 2a of the chemical agent tank 2. When the chemical agent level in the chemical agent tank 2 is lower than this position, pure water is supplemented to the chemical agent tank 2. In other words, when the chemical agent 9 stored in the chemical agent tank 2 is reduced, the chemical agent emerges through the front end 4c of the chemical agent outlet of the outlet reflex path 4b to the liquid level of the chemical agent 9 in the chemical agent tank 2, and more bubbles are generated at the liquid level due to the impact of the refluxed chemical agent 9, which is undesirable. Also, as most of the bubbles generated are aggregated near the liquid level, the bubbles are highly probable being sucked by the circulating pump 3 from the inlet of the chemical agent supply path 6 due to the decrease of the liquid level. As a result, airlock of the circulating pump 3 occurs, resulting in a negative effect. Therefore, in order to avoid the situation described above, the liquid level sensor 19 is disposed in a position that is sufficiently high, so as to detect the liquid level height at which sufficient amount of the chemical agent is circulated during cleaning.

The controller 20 is input with the detection signals from the liquid level sensors 16 and 17, and drives the valve driving mechanism 8 according to the detection signals. Accordingly, the open/close control of the switch valve 5 is performed for allowing the chemical agent 9 to reflux to the chemical agent tank 2, or the drive of the circulating pump 3 is controlled according to the detection signal from the liquid level sensor 18, or the pure water supplement to the chemical agent tank 2 is controlled according to the detection signal from the liquid level sensor 19.

Hereinafter, referring to the flow chart of process steps of the circulation control of chemical agent in FIG. 2, an example of the circulating cleaning method with the chemical agent 9 performed with the controller 20 is illustrated. According to the flow chart of FIG. 2, the processing is performed repeatedly in a specified period.

First, chemical agent rinse tank 11 is fully filled with the chemical agent 9. In the overflow tank 13, the liquid level of the chemical agent 9 is higher than the upper side of the detecting position of the liquid level sensor 16, and lower than the lower side of the detecting position of the liquid level sensor 17. Furthermore, in the chemical agent tank 2, the liquid level of the chemical agent 9 is sufficiently higher than the upper side of the detecting position of the liquid level sensor 19, and it is presumed that the switch valve 5 is in a closed condition.

In this condition, if the chemical agent cleaning apparatus 10 is movable, in Step 101, the controller 20 determines whether a detecting signal of the liquid level sensor 19 is present. Based on the above presumption, since the liquid level in the chemical agent tank 2 is sufficiently higher than the upper side of the detecting position of the liquid level sensor 19, the detecting signal from the liquid level sensor 19 is determined as “NO” as in Step 101. Therefore, the controller 20 generally proceeds to the Step 102. In Step 101, when the detecting signal is determined as “YES”, the process then skips to Step 110.

In Step 102, whether the circulating pump 3 is driving is determined. When the circulating pump 3 is not driving (“NO”), the process continues to Step 103. When the circulating pump 3 is driving (“YES”), the process skips to Step 104.

According to the detecting signal from the liquid level sensor 19, Step 103 is performed under the following situation. In Step 101, the liquid level in the chemical agent tank 2 is detected to be higher than the low limit position for starting to supplement pure water, and that the circulating pump 3 is not driving is detected in Step 102. In the Step 103, the controller 20 drives the driving circulating pump 3 and the ultrasonic generating apparatus 14 together to perform the ultrasonic cleaning. Accordingly, the chemical agent 9 of the chemical agent tank 2 is sequentially delivered into the chemical agent rinse tank 11, so that the chemical agent 9 is provided to the chemical agent rinse tank 11, while the ultrasonic cleaning of the disks is concurrently performed.

In Step 102, when the circulating pump is determined to be driving (“YES”), the process skips to Step 104, in which whether the detecting signal of the liquid level sensor 17 is present is being monitored.

The chemical agent rinse tank 11 is sequentially provided with the chemical agent 9 from the chemical agent tank 2, and along with the increase of the amount of the chemical agent 9 being provided, the chemical agent 9 overflows out of the chemical agent rinse tank 11. In the overflow tank 13, due to the residual chemical agent as shown in FIG. 1, the chemical agent 9 is slowly accumulated upwards, and the liquid level thereof rises over time. Along with the increase of the amount the chemical agent 9 provided from the chemical agent tank 2 to the chemical agent rinse tank 11, the liquid level of the chemical agent 9 of the overflow tank 13 reaches the position of the liquid level sensor 17 in a short time. When the liquid level of the chemical agent 9 of the overflow tank 13 reaches the upper limit F_{H}, the detecting signal is delivered from the liquid level sensor 17 to the controller 20.

In Step 104, the controller 20 monitors whether the detecting signal of the liquid level sensor 17 is present. When the detecting signal is present (“YES”), the process continues to the Step 105. When no detecting signal is present (“NO”), the process skips to Step 106. In other words, when no detecting signal is input to the controller 20 from the liquid level sensor 17, it is determined by the controller 20 as being “NO”. In the Step 105, when it is determined to be “NO”, the controller 20 proceeds to Step 106 to monitor whether the detecting signal of the liquid level sensor 16 is present.

In Step 105, the controller 20 receives the detecting signal from the liquid level sensor 17, so as to open (“ON”) the switch valve 5. Meanwhile, the liquid level of the chemical agent 9 of the chemical agent tank 2 may drop to the dotted line position of the time point when the chemical agent should be supplemented (near the detecting position of the liquor sensor 19). Owing to the opening of the switch valve 5, the chemical agent 9 of the overflow tank 13 returns to the chemical agent tank 2, and the liquid level of chemical agent 9 of overflow tank 13 descends slowly to the detecting position of the liquid level sensor 16. Conversely, the liquid level of chemical agent 9 of the chemical agent tank 2 rises to the original liquid level slowly.

In Step 106, the controller 20 monitors whether the detecting signal of the liquid level sensor 16 is present. When the detecting signal is present (“YES”), the process proceeds to the Step 107. When no detecting signal is presents (“NO”), the process skips to Step 108. In other words, when no detecting signal is input to the controller 20 from the liquid level sensor 16, it is determined by the controller 20 as “NO”. In the Step 106, when is the decision is determined to be “NO”, the process continues to Step 108 for the controller to monitor whether the detecting signal of the liquid level sensor 18 is present. On the other hand, when the liquid level of the chemical agent 9 of overflow tank 13 arrives at the liquid level sensor 16, the detecting signal is delivered from the liquid level sensor 16 to the controller 20; thus, the decision in Step 106 is determined to be “YES”, and the process continues to Step 107.

In Step 107, as the liquid level of the chemical agent 9 of the overflow tank 13 arrives at the liquid level sensor 16, the controller 20 performs the “off” control process to turn off the switch valve 5. Accordingly, during a common cleaning treatment, the on/off control of the switch valve 5 is performed according to the determinations made in the Step 104 and the Step 106, and the liquid level of chemical agent 9 of overflow tank 13 displaced between the position F_{L} at which the air bubbles are prevented from being discharged to the liquid level height F_{H}.

In Step 108, the controller 20 monitors whether the detecting signal from the liquid level sensor 18 is present. When the detecting signal is present (“YES”), the process proceeds to Step 110; when no detecting signal is presents (“NO”), the process skips to Step 109. In other words, when no detecting signal is input to the controller 20 from the liquid level sensor 18, it is determined by the controller 20 to be “NO”. In the Step 108, when the decision is determined to be “NO”, the controller 20 turns to Step 109 to determine whether the treatment has been completed. In Step 108, the determination of the present of the detecting signal of the liquid level sensor 18 (“YES”) refers to the situation that airlock occurs in the reflux path for some reasons, and the chemical agent has stopped overflowing from the overflow tank 13. Thus, the process continues to step 110 for the controller 20 to stop the cleaning treatment immediately.

In Step 109, the controller 20 determines whether the cleaning treatment is over. When the cleaning treatment is not over (“NO”), the process continues to Step 101, and a series of the process steps of Steps 101-109 is repeated. Contrary, when the cleaning treatment is determined to be over (YES) in Step 109, the process proceeds to Step 110.

In Step 110, the processing thereof is performed upon obtaining the detecting signal of the liquid level sensor 19, or upon obtaining the detecting signal of the liquid level sensor 19 in Step 108. In other words, in Step 110, similar to the process step when the cleaning processing is completed, the controller 20 stops driving the circulating pump 3 and the ultrasonic generating apparatus 14 to end the cleaning treatment.

In addition, in the state that the valve 5 is closed, when the chemical agent is being circulated, in order to for the time point of the detecting signal output from the liquid level sensor 18 be substantially identical to the time point of the detecting signal output from the liquid level sensor 19, the stored amount in the chemical agent tank 2 or the overflow tank 13 is set. Accordingly, if the liquid level sensor 18 is defected and inoperable, the apparatus can also stop functioning according to the detecting signal from the liquid level sensor 19, so as to prevent the chemical agent from overflowing out of the overflow tank 13.

Additionally, in the embodiment described above, when the circulating pump 3 is movable, the controller 20 determines that the detecting signals from the liquid level sensor 18 and 19 have been received, and stops the circulating pump immediately. At the same time, upon receiving the signal from the liquid level sensor 19, the operator can be informed on the sudden termination of the apparatus by the display of the pure water supplement on the CRT display.

Furthermore, after it is being determined that the detecting signal from the liquid level sensor 17 is present (“YES”) in Step 104, and the switch valve 5 is opened, and further it is determined that the detecting signal from the liquid level sensor 17 is present (“YES”) in step 105, the process can skip to Step 110. Within a fixed timer period after the detecting signal from the liquid level sensor 17 is determined to be present (“YES”) in Step 104, and the detecting signal from the liquid level sensor 16 has not been determined to be present (“YES”), airlocks or failures occur, or malfunctioning occurs in detecting the circulating manner, the process can proceeds to Step 110. It is preferably, at this time, that the user is informed of the reasons on the sudden termination of the process on the CRT display.

In the embodiment described above, the situation of performing the on/off control of the switch valve 5 is illustrated. By using a valve that can properly control the opening of the switch valve 5 the liquid level height of the circulating chemical agent in the overflow tank 13 is controlled to range from the position F_{L} for preventing air bubbles from being discharged to liquid level height F_{H}.

In the present embodiment, the ultrasonic cleaning apparatus is illustrated as an example. However, it is appreciated that the present invention is limited to the ultrasonic apparatus. When the product cleaning is performed in a chemical agent circulating system with an overflow tank to allow the chemical agent to flow from the overflow tank back to the chemical agent tank, the present invention is also applicable in the various systems that might generate air bubbles in the overflow tank, without being limited to the ultrasonic cleaning apparatus.

What is claimed is:

1. A chemical agent cleaning method, in which a product is immersed into a chemical agent in a chemical agent rinse tank, the method comprising the following steps:
providing the chemical agent from a chemical agent storing tank to the chemical agent rinse tank, wherein the chemical agent storing tank is disposed in a position lower than that of the chemical agent rinse tank;
storing the chemical agent overflowed from the chemical agent rinse tank in an overflow tank temporarily; and
refluxing the chemical agent from the overflow tank to the chemical agent storing tank at a time point when an amount of the chemical agent stored in the overflow tank arrives at a first setting value, which is at a position lower than the upper end portion of a wall of the overflow tank, and ceasing the chemical agent to reflux from the overflow tank to the chemical agent storing tank, and maintaining the chemical agent being stored in the overflow tank at a time point when the amount of the chemical agent stored in the overflow tank arrives at a second setting value due to the refluxing of the chemical agent, which is at a position lower than the first setting value.

2. The chemical agent cleaning method as claimed in claim 1, wherein the position of the amount of the chemical agent stored in the overflow tank is lower than the upper end portion of the wall of the overflow tank, and the chemical agent cleaning method comprises the following step:
, ceasing the operation of each step above, so as to prevent the chemical agent from overflowing out of the overflow tank at a time point when the amount of the chemical agent stored arrives at a third setting value, which is at a position higher than the first setting value.

3. The chemical agent cleaning method as claimed in claim 2, wherein the position of the first setting value is higher than that of the second setting value, and lower than the upper end portion of the wall of the overflow tank and the position of the third setting value.

4. The chemical agent cleaning method as claimed in claim 3, wherein the position of the second setting value is set to be near a height of the liquid level at which spiral vortexes are generated in the chemical agent in the overflow tank.

5. The chemical agent cleaning method as claimed in claim 1, comprising the following steps:
stopping the operation of each step above and supplementing pure water to the chemical agent storing tank at a time point when the amount of the chemical agent stored in the chemical agent storing tank arrives at a fourth setting value, which is at a position at which no bubbles floating in the chemical agent storing tank is mixed into the chemical agent provided to the chemical agent rinse tank from the chemical agent storing tank.

6. A chemical agent cleaning apparatus, in which a product is immersed into a chemical agent to be cleaned, comprising:
a chemical agent rinse tank, for storing a chemical agent for cleaning the product;
an overflow tank, for temporarily storing the chemical agent overflowed from the chemical agent rinse tank;
a chemical agent storing tank, disposed in a position lower than those of the chemical agent rinse tank and the overflow tank, for storing the chemical agent provided to the chemical agent rinse tank, and storing the chemical agent refluxed from the overflow tank;
a first detecting means, for detecting that the amount of the chemical agent stored in the overflow tank has reached a first setting value, which is at a position lower than the upper end portion of a wall of the overflow tank;
a second detecting means, for detecting that the amount of the chemical agent stored in the overflow tank has reached a second setting value, which is at a position lower than that of the first setting value;
a controlling means, for allowing the chemical agent to reflux from the overflow tank to the chemical agent storing tank according to a detection signal from the first detecting means, and allowing the chemical agent to stop refluxing from the overflow tank to the chemical agent storing tank according to a detection signal from the second detecting means, and maintaining the chemical agent being stored in the overflow tank.

7. The chemical agent cleaning apparatus as claimed in claim 6, comprising a third detecting means, which detects the amount of the chemical agent stored in the overflow tank at the position at the upper end portion of the wall of the overflow tank has reached a third setting value which is in a position higher than that of the first setting value, for stopping the chemical agent from flowing back, and preventing the chemical agent from overflowing out of the overflow tank.

8. The chemical agent cleaning apparatus as claimed in claim 7, wherein the position of the first setting value is higher than that of the second setting value, and lower than the upper end portion of the wall of the overflow tank and the position of the third setting value.

9. The chemical agent cleaning apparatus as claimed in claim 6, wherein the position of the second setting value is set to be higher than a level near a height of the liquid level at which spiral vortexes are generated in the chemical agent of the overflow tank.

10. The chemical agent cleaning apparatus as claimed in claim 6, comprising a fourth detecting means, wherein the operation of each step above stops, and a supply of pure water to the chemical agent storing tank commences at a time point when the amount of the chemical agent stored in the chemical agent storing tank arrives at a fourth setting value, which is at a position where no bubbles floating in the chemical agent storing tank is mixed into the chemical agent provided to the chemical agent rinse tank from the chemical agent storing tank.

11. The chemical agent cleaning apparatus as claimed in claim 6, comprising the third detecting means and the fourth detecting means,
wherein the third detecting means detects that the amount of the chemical agent stored in the overflow tank at a position lower than the upper end portion of the wall surface of the overflow tank has reached the third setting value which is at a position higher than that of the first setting value, for stopping the chemical agent from flowing back, and preventing the chemical agent from overflowing out of the overflow tank;
wherein the fourth detecting means detects that the amount of the chemical agent stored in the overflow tank has reached the fourth setting value, which is at a position of which no bubbles floating in the chemical agent storing tank is mixed into the chemical agent provided to the chemical agent rinse tank from the chemical agent storing tank, for stopping the chemical agent from flowing back and starting to supply pure water to the chemical agent storing tank; and
wherein a time point at which the third detecting means detects the third setting value is set to be substantially the same as a time point at which the fourth detecting means detects the fourth setting value.

12. The chemical agent cleaning apparatus as claimed in claim 6, wherein the controlling means is used for performing an on/off control for starting or stopping the reflux of the chemical agent, and a switch valve, disposed in the flow path for allowing the chemical agent to reflux from the overflow tank to the chemical agent storing tank.

13. The chemical agent cleaning apparatus as claimed in claim 6, wherein the apparatus is driven and controlled by the control means, and a circulating pump provides the chemical agent from the chemical agent storing tank to the chemical agent rinse tank.

14. The chemical agent cleaning apparatus as claimed in claim 6, wherein the product is a hard disk or an optical disk.

15. The chemical agent cleaning apparatus as claimed in claim 6, wherein the chemical agent rinse tank is an ultrasonic rinse tank.
